(19) United States
(12) Patent Application Publication
(10) Pub. No.: US 2025/0316936 A1
(43) Pub. Date: Oct. 9, 2025

(54) CONNECTOR AND CONNECTOR ASSEMBLY

(71) Applicant: OUTDOOR WIRELESS NETWORKS LLC, Richardson, TX (US)

(72) Inventors: Jien Zheng, Suzhou (CN); ZhaoHui Liu, Suzhou (CN); Hongjuan An, Suzhou (CN); MuLan Huang, Suzhou (CN)

(21) Appl. No.: 19/095,880

(22) Filed: Mar. 31, 2025

(30) Foreign Application Priority Data
Apr. 7, 2024 (CN) 202410408030.X

(51) Int. Cl. H01R 24/40; H01R 103/00

(52) U.S. Cl. CPC H01R 24/40; H01R 2103/00

(57) ABSTRACT

The present disclosure relates to a connector assembly comprising a coaxial central conductor and an outer conductor, wherein the connector further comprises a coupling member connected to the outer conductor and configured to couple with a mating coupling member of a mating connector; a sleeve surrounding the outer conductor and is capable of moving between the locked position and unlocked position relative to the outer conductor; at least one columnar member coupled to the outer conductor; at least one slot formed on the sleeve and mated with the columnar member, the slot having a guiding section and a locking section, in which when the sleeve moves between the locked position and the unlocked position, the columnar member is capable of guiding the sleeve in the guiding section of the slot and when the sleeve is in the locked position, the columnar member is capable of stopping in the locking section of the sleeve such that the sleeve is able to remain in the locked position when subjected to an axially rearward tension. The present disclosure further relates to a connector assembly.

### RELATED APPLICATION

The present application claims priority from and the benefit of Chinese Patent Application No. 202410408030.X, filed Apr. 7, 2024, the disclosure of which is hereby incorporated herein by reference.

### FIELD OF THE INVENTION

The present disclosure relates to a connector and a connector assembly.

### BACKGROUND OF THE INVENTION

The coaxial cable is a bipolar cable having a concentric structure, the cable having a central conductor enclosed by a hollow outer conductor by a certain spacing. The outer conductor is a central conductor that shields electromagnetic interference radiation. An insulator is disposed within the intermediate space between the central conductor and the outer conductor. A coaxial connector is used to loosely connect the coaxial cables to each other. The coaxial connector has the same coaxial design as the coaxial cable such that it has the advantages of the coaxial cable.

A variety of radio frequency (RF) coaxial connectors are known.

Some existing coaxial connectors are connected by a threaded connection, but the tightening and loosening of the thread is relatively time consuming for the installing technician, and the use of a wrench increases installation complexity and danger (e.g., accidental drop).

Some existing coaxial connectors connect the two by means of a connection auxiliary member disposed outside of the two connectors, but this may adversely affect aesthetics.

Some existing coaxial connectors are configured as push-pull connectors. These push-pull connectors are often used with waterproof covers. When a waterproof cover needs to be pulled down from the connector, the coupling of the two connectors may be accidentally unlocked and cause undesirable separation of the two from each other.

### SUMMARY OF THE INVENTION

Therefore, the present disclosure aims to provide a connector and connector assembly that are capable of resolving at least one of the technical problems set forth above present in the prior art.

According to one aspect of the present disclosure, a connector comprising a coaxial central conductor and an outer conductor is provided, wherein the connector further comprises
a coupling member connected to the outer conductor and configured to couple with a mating coupling member of a mating connector;
a sleeve surrounding the outer conductor and is capable of moving between the locked position and unlocked position relative to the outer conductor, the sleeve in the locked position being capable of locking the coupling between the coupling member and the mating coupling member to prevent decoupling of the two, and the sleeve in the unlocked position is capable of allowing decoupling of the coupling member with the mating coupling member;
at least one columnar member connected to the outer conductor; and
at least one slot formed on the sleeve and mated with the columnar member, the slot having a guiding section and a locking section,
in which when the sleeve moves between the locked position and the unlocked position, the columnar member is capable of guiding the sleeve in the guiding section of the slot and when the sleeve is in the locked position, the columnar member is capable of stopping in the locking section of the sleeve such that the sleeve is able to remain in the locked position when subjected to an axial rearward tension.

In some examples, the guiding section of the slot extends obliquely longitudinally and transversely relative to the sleeve such that movement of the sleeve between the locked position and the unlocked position comprises a helicoidal motion.

In some examples, the columnar member secures the coupling member to the outer conductor.

In some examples, the connector further comprises a spring tensioned between the outer conductor and sleeve that is capable of applying a rearward force to the sleeve.

In some examples, the locking section has a front stop cavity in the front where, when the sleeve is in the locked position, the spring applies an axial rearward force to the sleeve such that the columnar member stops in the front stop cavity, the front stop cavity having a front shoulder that is adjacent to the guiding section of the slot and circumferentially stops the columnar member.

In some examples, less than half of the columnar members are received in the front stop cavity when the sleeve is in the locked position.

In some examples, the locking section has a rear stop cavity in the rear that has a rear shoulder adjacent to the guiding section of the slot, the rear stop cavity being capable of circumferentially stopping the columnar member when the columnar member enters the rear stop cavity.

In some examples, the coupling member has a base secured to the outer conductor and a plurality of coupling fingers spaced apart by a slit connected to the base in the front, in which the sleeve abuts the coupling fingers from the front in the unlocked position with the force of the spring.

In some examples, the sleeve in the locked position is capable of abutting the coupling fingers from the radial outside with the inner surface thereof to prohibit the coupling fingers from moving radially outward.

In some examples, the slot also has a decoupling section that extends longitudinally parallel to the sleeve, and when the sleeve is in the unlocked position, the columnar member is located in the decoupling section and is spaced apart from the front end of the decoupling section, the spacing decreasing after the coupling of the coupling member with the mating coupling member is decoupled by pulling the sleeve rearward.

In some examples, each coupling finger has a hook-shaped portion having a front end, the hook-shaped portion has an outer section located radially outside, a front section located in the front, and an inner section located radially inside, with the front section extending obliquely.

In some examples, in the coupled state of the coupling member and mating coupling member, the inner section is latched in the mating coupling member that is constructed as a recess of the matching connector.

In some examples, when the sleeve is in the locked position, the inner section is latched in the mating coupling member constructed as a recess of the matching connector, and the sleeve abuts the outer section from the radial outside with the inner surface thereof.

In some examples, the base is constructed as a circumferentially closed ring that is sleeved on the outer conductor.

In some examples, the outer conductor is provided with at least one radial outwardly open blind via and the coupling member is provided with at least one through hole, and each columnar member is inserted in the slot with one through hole on the lower portion thereof and one blind via on the outer conductor, as well as with the upper portion thereof.

In some examples, the columnar member is constructed as a pin pressed into the through hole and blind via with an interference fit, or the columnar member is constructed as a columnar threaded member that has a threaded connection with at least one of the through hole and blind via.

In some examples, the slot is constructed to be circumferentially closed.

According to another aspect of the present disclosure, a connector assembly is provided, wherein the connector assembly comprises a connector and a mating connector according to the present disclosure, in which the mating connector comprises a coaxial central conductor and an outer conductor.

In some examples, the connector assembly is equipped with a cover radially outside, and when the connector and the mating connector are in the coupled and locked state, the waterproof cover is secured to the cable in the rear of the connector with the rear end thereof and in front of the sleeve with the front end thereof.

In some examples, the front end of the cover that is constructed as a hook-shaped portion is latched in the recess of the mating connector.

Those skilled in the art will appreciate the advantages of the corresponding examples and various additional examples by reading the following detailed description of the respective examples with reference to the attached drawings listed below.

### DESCRIPTION OF THE DRAWINGS

The present disclosure is further illustrated below with reference to the attached drawings and examples, in which:

FIG. 1A shows a schematic side view of a male connector and a female connector that are in a state separated from each other, according to an example of the present disclosure,

FIG. 1B shows a corresponding schematic longitudinal cross-sectional view of the male connector and female connector in FIG. 1,

FIG. 1C shows a corresponding schematic stereoscopic view of the male connector and female connector in FIG. 1,

FIG. 2A shows a schematic exploded view of the male connector in FIG. 1,

FIG. 2B shows a schematic longitudinal cross-sectional view of an elastic coupling member of the male connector in FIG. 2A,

FIG. 2C shows a schematic longitudinal cross-sectional view of the sleeve of the male connector in FIG. 2A,

FIG. 2D shows a corresponding schematic stereoscopic view of the exploded male connector in FIG. 2A,

FIG. 3A shows a schematic side view of the male connector and female connector according to FIG. 1A in a state coupled to each other but not locked,

FIG. 3B shows a corresponding schematic longitudinal cross-sectional view of the male connector and female connector in FIG. 3A,

FIG. 4A shows a schematic side view of the male connector and female connector according to FIG. 1A in a state coupled to each other and locked,

FIG. 4B shows a corresponding schematic longitudinal cross-sectional view of the male connector and female connector in FIG. 4A,

FIG. 5A shows a schematic side view of the male connector and female connector according to FIG. 1A in an unlocked state and decoupled from each another,

FIG. 5B shows a corresponding schematic longitudinal cross- sectional view of the male connector and female connector in FIG. 5A,

FIG. 6A shows a schematic side view of the male connector and female connector according to FIG. 1A in a state coupled to each other and locked along with a waterproof cover sleeved thereon,

FIG. 6B shows a corresponding schematic longitudinal cross-sectional view of the male connector and female connector along with a waterproof cover according to FIG. 6A, and

FIG. 6C shows a schematic longitudinal cross-sectional view of the male connector and female connector along with the waterproof cover according to FIG. 6A, but with the waterproof cover pulled back.

### DETAILED DESCRIPTION OF SPECIFIC EMBODIMENTS

The present disclosure will be described below with reference to the attached drawings, which show several examples of the present disclosure. However, it should be understood that the present disclosure can be presented in many different ways and is not limited to the examples described below. In fact, the examples described below are intended to make the present disclosure more complete and to fully explain the protection scope of the present disclosure to those skilled in the art. It should also be understood that the examples disclosed in the present disclosure may be combined in various ways so as to provide more additional examples.

It should be understood that in all the attached drawings, the same symbols denote the same elements. In the attached drawings, the dimensions of certain features can be changed for clarity.

It should be understood that the words in the specification are only used to describe specific examples and are not intended to limit the present disclosure. Unless otherwise defined, all terms (including technical terms and scientific terms) used in the Specification have the meanings commonly understood by those of ordinary skill in the art. For brevity and/or clarity, well-known functions or structures may not be further described in detail.

The singular forms “a”, “an”, “the” and “this” used in the Specification all include plural forms unless clearly indicated. The words “comprise”, “contain” and “have” used in the Specification indicate the presence of the claimed features, but do not exclude the presence of one or more other features. The word “and/or” used in the Specification includes any or all combinations of one or a plurality of the related listed items. The words “between X and Y” and “between approximate X and Y” used in the Specification shall be interpreted as including X and Y. As used herein, the wording “between approximate X and Y” means “between approximate X and approximate Y”, and as used herein, the wording “from approximate X to Y” means “from approximate X to approximate Y”.

In the Specifications, when it is described that an element is “on” another element, “attached” to another element, “connected” to another element, “coupled” with another element, or “in contact with” another element, etc., the element may be directly on another element, attached to another element, connected to another element, coupled with another element, or in contact with another element, or an intermediate element may be present. In contrast, if an element is described as “directly” “on” another element, “directly attached” to another element, “directly connected” to another element, “directly coupled” to another element, or “directly in contact with” another element, no intermediate elements are present. In the Specification, a feature that is arranged “adjacent” to another feature, may denote that a feature has a part that overlaps an adjacent feature or a part located above or below the adjacent feature.

In the Specification, words expressing spatial relations such as “upper”, “lower”, “left”, “right”, “front”, “rear”, “top”, and “bottom” may describe the relation between one feature and another feature in the attached drawings. It should be understood that, in addition to the locations shown in the attached drawings, the words expressing spatial relations further include different locations of a device in use or operation. For example, when a device in the attached drawings is turned upside down, the features originally described as being “below” other features now can be described as being “above” the other features”. The apparatus may also be oriented in other ways (rotated 90 degrees or in other orientations), and the relative spatial relationships will be interpreted accordingly in those cases.

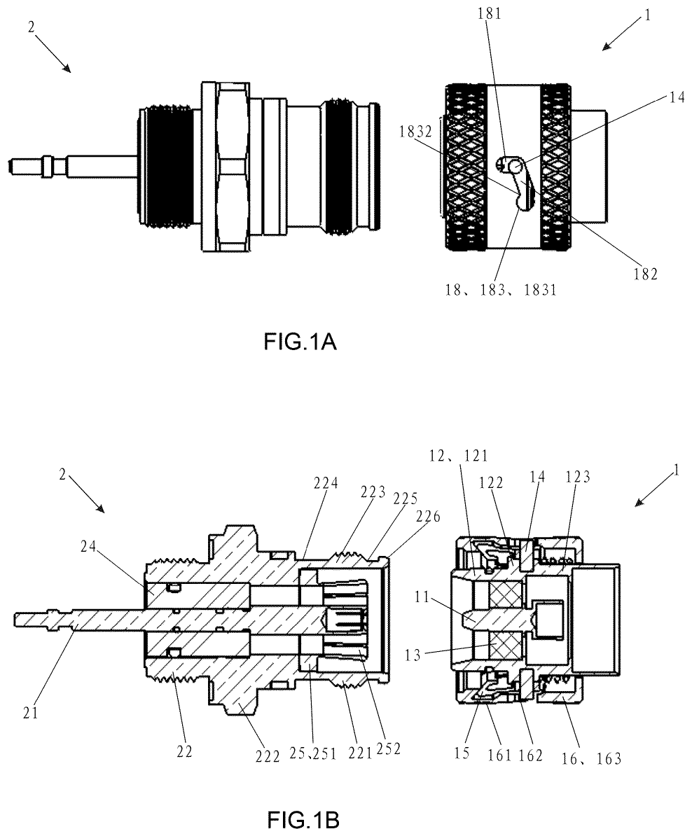

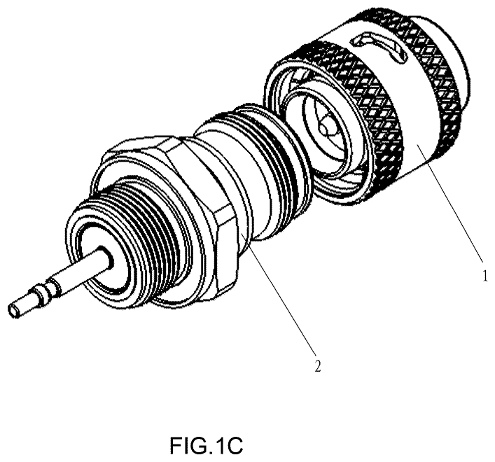

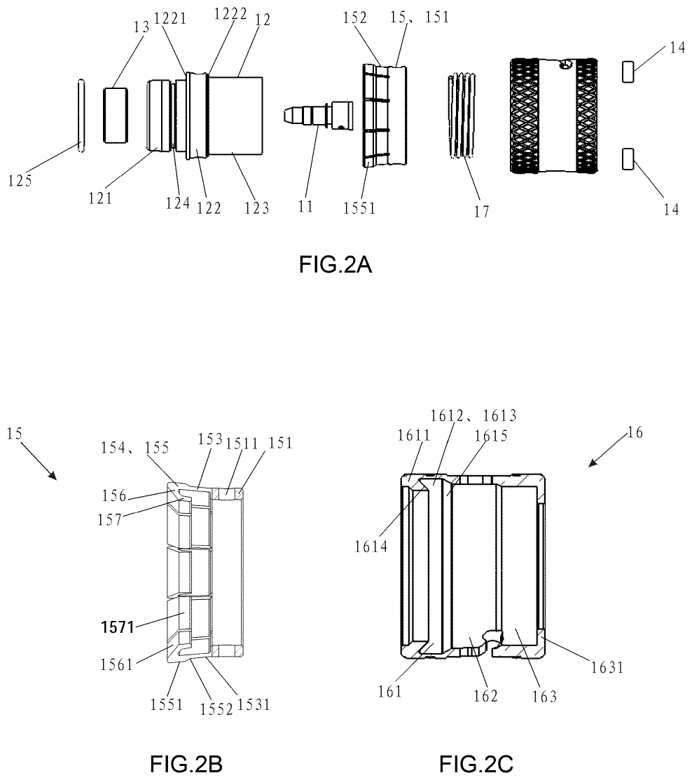

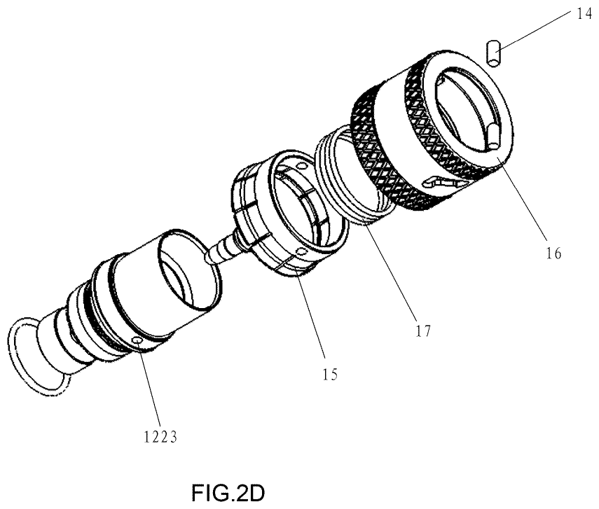

FIGS. 1A-1C show different views of the male connector 1 (right side) and the matching female connector 2 (left side) before being coupled, respectively, and FIGS. 2A-2D show an exploded view of the male connector 1 or a cross-sectional view of components thereof, according to an example of the present disclosure. The male connector 1 may also be referred to as a cable or jumper-side connector 1, while the female connector 2 may be referred to as a device-side connector 2. The device (not shown) using the female connector 2 may be, for example, a base station antenna, a remote radio unit, etc. The male connector 1 and the female connector 2 may be coupled and separated in a push-pull manner, so the two may form a push-pull or quick-lock coaxial connector assembly together.

Referring to the figures, in the following description, the direction of the male connector 1 from right to left may correspond to the rear to front direction thereof, and the direction of the female connector 2 from left to right may correspond to the front to rear direction thereof.

Referring to FIG. 1B, the female connector 2 may comprise a central conductor 21, an outer conductor 22, and an insulating spacer 24 between the central conductor 21 and outer conductor 22. The central conductor 21 is largely columnar and the rear end thereof may be electrically connected and mechanically connected to the central conductor of the corresponding interface (not shown) of the first cable or device. The insulating spacer 24 may be used to insulate and space apart the central conductor 21 and outer conductor 22, and secure the central conductor 21 at a radial central position of the outer conductor 22. The outer conductor 22 is largely cylindrical, and the rear end thereof may be electrically connected and mechanically connected to the outer conductor of the corresponding interface (not shown) of the first cable or device.

The outer conductor 22 of the female connector 2 may comprise a front section 221 having a larger inner diameter and a rear section 222 having a smaller inner diameter. The inner side of the rear section 222 may be used to receive and secure the insulating spacer 24. The inner side of the front section 221 may be used to receive and secure an elastic bracket 25. The elastic bracket 25 has an annular base 251 and an elastic finger-shaped portion 252 that protrudes forward from the radial inside portion of the annular base 251. The annular base 251 may be secured and abutted to the front end surface of the rear section 222 and the inner surface of the front section 221, with a gap formed between the inner surface of the front section 221 and the finger-shaped portion 252.

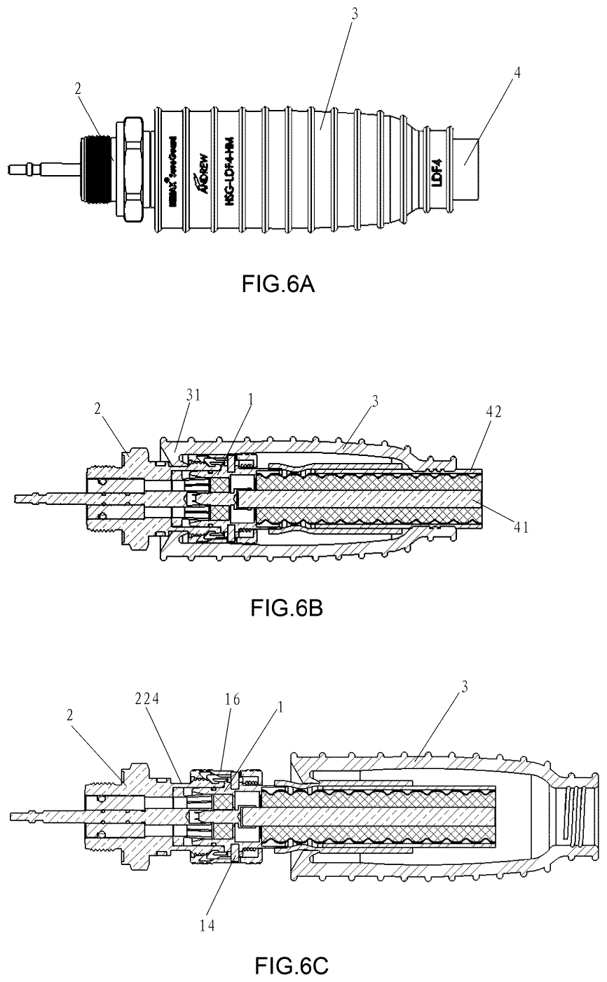

The front section 221 may have a surrounding boss 223 on the outer surface thereof. The boss 223 may be provided with an external thread on the outer surface thereof that allows the female connector 2 to have a threaded connection with a conventional male connector with an internal thread, but the disposition of the external thread is not required here. A rear recess 224 that is radially inwardly recessed relative to the outer surface of the boss 223 may be provided at the rear of the boss 223 on the outer surface of the front section 221, the rear recess 224 may be axially defined by a vertical rear sidewall and an inclined front sidewall located on the boss 223. The rear recess 224 may be used to achieve a latch connection of the female connector 2 to the waterproof cover 3 in the installed state of the waterproof cover 3 (refer to FIG. 6B). A front recess 225 that is radially inwardly recessed relative to the outer surface of the boss 223 may be provided in the front of the boss 223 on the outer surface of the front section 221, the front recess 225 may be axially defined by an inclined rear sidewall located on the boss 223 and a vertical front sidewall located on a front flange 226. The flange 226 may be located at the front-most end of the front section 221.

The male connector 1 may comprise a central conductor 11, an outer conductor 12, and an insulating spacer 13 between the central conductor 11 and outer conductor 12. The central conductor 11 is largely columnar and the rear end thereof is electrically connected and mechanically connected to a central conductor 41 of a second cable 4 (refer to FIGS. 6A and 6B), while the front end thereof may be inserted into the front recess of the central conductor 21 of the female connector 2. The insulating spacer 13 is used to insulate and space apart the central conductor 11 from the outer conductor 12. The outer conductor 12 may be largely cylindrical and electrically connected and mechanically connected to an outer conductor 42 of the second cable 4 at the rear end thereof (refer to FIGS. 6A and 6B).

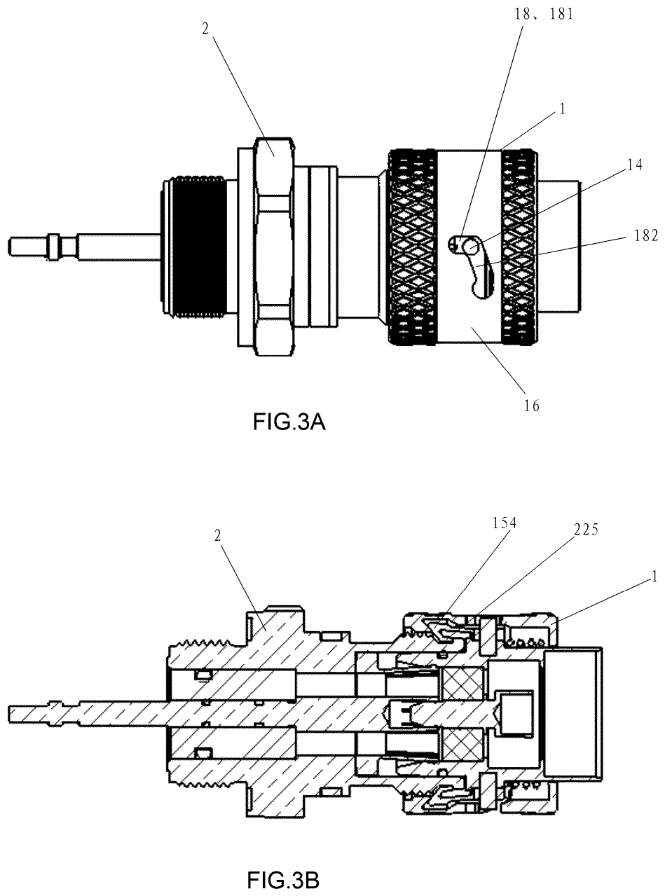

The outer conductor 12 may comprise a successively arranged front section 121, a middle section 122 and a rear section 123. The outer diameter of the front section 121 may be slightly smaller than the inner diameter of the front section 221 of the female connector 2, such that the front section 121 may be inserted into the radial inner side of the front section 221 when the male connector 1 and female connector 2 are in the coupled state, particularly inserted between the front section 221 and the elastic bracket 252, thereby facilitating the establishment of electrical contact between the two outer conductors 12 and 22 (refer to FIG. 3B). A ring groove 124 may be provided on the outer surface of the front section 121 and may receive a sealing ring 125 that is capable of ensuring an axial seal between the two front sections 121, 221 (refer to FIGS. 2A and 3B).

The middle section 122 may form a surrounding protrusion that protrudes radially outward relative to the outer surface of the front section 121 and the rear section 123. Therefore, the middle section 122 may form a front convex shoulder surface 1221 (refer to FIG. 2A) that is adjacent to and is, for example, perpendicular to the outer surface of the front end section 121 at the front end thereof. In the coupled state of the male connector 1 and the female connector 2, the front end surface of the front section 221 of the female connector 2 or the front end of the flange 226 may stop on the front convex shoulder surface 1221. The rear end of the middle section 122 may form a rear convex shoulder surface 1222 that is adjacent to and is, for example, perpendicular to the outer surface of the rear section (refer to FIG. 2A). The middle section 122 may be provided with a radially outwardly open receiving hole 1223 (refer to FIG. 2D) in the axially generally middle position thereof, which is a blind via here. The receiving hole 1223 may be used to receive and secure the pin 14 as further described below. Here, two opposing receiving holes 1223 may be disposed. Of course, it is also possible to conceive of only disposing one receiving hole 1223, or more than two receiving holes 1223. The plurality of receiving holes 1223 may be arranged at the same distance circumferentially spaced from the middle section 122.

The male connector 1 may further comprise an elastic coupling member 15, referring to FIG. 2A, FIG. 2B and FIG. 2D, the coupling member 15 may have an annular base 151 and a plurality of elastic largely finger-shaped coupling fingers 152 extending forwardly from the base 151. There are 10 coupling fingers 152 in this example, but more or less coupling fingers 152 may also be conceived. These coupling fingers 152 are arranged on the front end surface of the base 151, particularly surrounding the radial outside of the front end surface, and spaced apart from one another by gaps (refer to FIG. 2B). These coupling fingers 152 undergo elastic deformation with respect to the radial motion of the base 151 when subjected to a radial force. Each coupling finger 152 may have a stalk portion 153 that is adjacent to the base 151 and a hook-shaped portion 154 that is adjacent to the stalk portion 153. The wall thickness of the stalk portion 153 may be less than the wall thickness of the base 151. The smaller wall thickness of the stalk portion 153 facilitates easier elastic deformation thereof. The stalk portion 153 may extend forwardly and slightly radially outwardly from the radial outside of the front end surface of the base 151 here. The hook-shaped portion 154 may be constructed as largely C-shaped and open towards the rear, or the base 151. The wall thickness of the hook-shaped portion 154 may be greater than the wall thickness of the stalk portion 153. The hook-shaped portion 154 may have an outer section 155 that is radially outside and that forms an inclined surface 1552 at the transition from the horizontal outer surface 1551 of the outer section 155 to the stalk portion 153, such that the diameter of the outer surface 1551 of the outer section 155 is greater than the diameter of the outer surface 1531 of the stalk portion 153, i.e., the two outer surfaces 1551, 1531 are radially staggered. The hook-shaped portion 154 may also have a front section 156 that is a C-bottom, and the front section 156 or the front surface 1561 thereof is constructed to extend radially inwardly and axially rearwardly obliquely from the outer section 155 or the outer surface 1551 thereof. The hook-shaped portion 154 may also have an inner section 157 that is radially inside and the inner section 157 or inner surface 1571 thereof (i.e., the surface with a smaller inner diameter) extends horizontally rearwardly from the front section 156 or the front surface 1561 thereof. The inclined front surface 1561 of the front section 156 may achieve radial outward expansion during insertion due to the hook-shaped portion 154 being extruded forwardly by the front end of the flange 226 of the female connector 2, and after the hook-shaped portion 154 slides past the flange 226, the inner section 157 of the hook-shaped portion 154 may reach and be received in the front recess 225 of the female connector 2 and abut against the vertical front sidewall of the front recess 225 at the free end thereof to complete coupling. Here, in the initial state before coupling of the male connector 1, i.e., in the initial state of the coupling finger 152 shown in FIG. 1B, the inner diameter of the inner section 157 (or the diameter of the inner surface 1571 thereof) may be designed to be smaller than the outer diameter of the flange 226, e.g., designed to be equal to or slightly smaller than the diameter of the bottom surface of the front recess 225. This allows the operator to tactilely feel (and hear) that the coupling is completed and facilitate the tactile (and aural) identification of the completion of the coupling the moment coupling is completed, i.e., when the inner section 157 enters the front recess 225.

The larger wall thickness of the hook-shaped portion 154 not only facilitates a firmer connection of the two connectors 1 and 2, but also achieves radial staggering of the outer surface 1551 of the outer section 155 of the hook-shaped portion 154 and the outer surface 1531 of the stalk portion 153.

A through hole 1511 corresponding to the receiving hole 1223 on the middle section 122 of the outer conductor 12 may be provided on the base 151 of the elastic coupling member 15. The elastic coupling member 15 may be sleeved on the middle section 122 with the base 151 thereof while the through hole 1511 on the base 151 of the elastic coupling member 15 and the receiving hole 1223 on the middle section 122 are aligned with one another. As such, the elastic coupling member 15 may be firmly secured to the middle section 122 via the pin 14. Here, the pin may be pressed into the through hole 1511 and the receiving hole 1223 with an interference fit. It may also be conceived to dispose a thread at the lower end of the pin, and to dispose a thread in the receiving hole 1223, such that the pin is capable of having a threaded connection with the receiving hole 1223.

The male connector 1 may further comprise a sleeve 16. The sleeve 16 may be largely cylindrical and be capable of enclosing a majority of the outer conductor 12 and the entire elastic coupling member 15. Referring to FIGS. 2A, 2C, and 2D, the sleeve 16 may have a front section 161, a middle section 162, and a rear section 163. The rear end at the rear section 163 of the sleeve 16 may be provided with a rear wall 1631 extending radially inwardly from a peripheral wall of the rear section 163, the rear wall 1631 surrounding the rear section 123 of the outer conductor 12 and mating with an outer surface gap of the rear section 163 that ensures not only coaxiality of the sleeve 16 with the outer conductor 12, but also allows for axial and circumferential motion of the sleeve 16 relative to the outer conductor 12. A spring 17 may be provided between the middle section 122 of the outer conductor 12 and the sleeve 16, and in particular, the spring 17 may abut the rear convex shoulder surface 1222 of the middle section 122 of the outer conductor 12 at the front end and abut a front side surface of the rear wall 1631 of the sleeve 16 at the rear end. The spring 17 may be a compressed preloaded spring 17 such that the spring 17 is capable of always exerting a rearward force on the sleeve 16 to prohibit any (e.g., due to gravity) forward rocking of the sleeve 16 relative to the outer conductor 12.

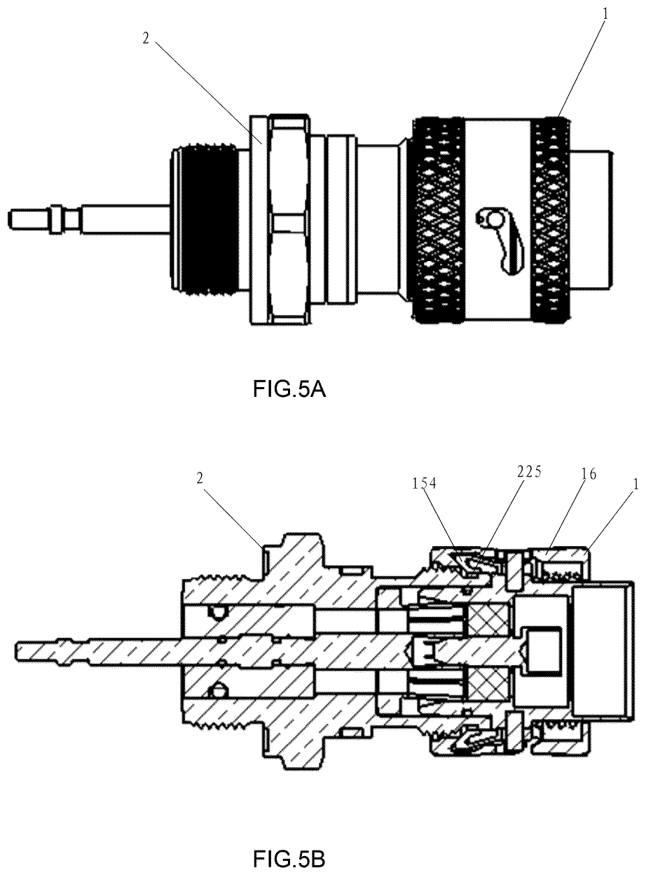

The sleeve 16 may form a hook-shaped decoupling portion 1611 on the front section 161 thereof, and the decoupling portion 1611 may be oriented toward the hook-shaped portion 154 of the elastic coupling member 15 and may cause the hook-shaped portion 154 to exit from the front recess 225 to achieve decoupling of the two connectors 1 and 2. The decoupling portion 1611 may form a capture cavity 1612 to capture the hook-shaped portion 154. The capture cavity 1612 may be defined by a horizontal top surface 1613, an inclined front surface 1614, and an inclined rear surface 1615. The inclined rear surface 1615 may be a transitional surface of the front section 161 towards the middle section 162, with a slope that largely corresponds to an inclined surface 1552 where the outer section 155 of the hook-shaped portion 154 of the elastic coupling member 15 transitions to the stalk portion 153. The slope of the inclined front surface 1614 of the capture cavity 1612 may largely correspond to the slope of the front surface 1561 of the hook-shaped portion 154 of the elastic coupling member 15. Therefore, referring to FIG. 1B, in the initial state of the male connector 1, the capture cavity 1612 may partially receive the hook-shaped portion 154 of the elastic coupling member 15 and the front surface 1614 of the capture cavity 1612 partially abuts the front surface 1561 of the hook-shaped portion 154 of the elastic coupling member 15 from the front. The coupling finger 152 of the elastic coupling member 15 may be slightly raised under the pre-tension of the spring 17. As such, the sleeve 16 is stopped by the elastic coupling member 15 to prohibit the sleeve 16 from moving rearwardly under the pre-tension of the spring 17. As such, in the initial state of the male connector 1, the sleeve 16 remains stable without rocking relative to the outer conductor 12 under the common action of the pre-tension of the spring 17 and the return force of the coupling finger 152 of the elastic coupling member 15. Further, by setting the degree of pre-tension of the spring 17, the degree to which the coupling finger 152 of the elastic coupling member 15 is raised in the initial state may be adjusted. Further, in the initial state of the male connector 1, the outer surface 1551 of the outer section 155 of the hook-shaped portion 154 of the elastic coupling member 15 may have a gap with the top surface 1613 of the capture cavity 1612 of the sleeve 16, and the height of the gap is for example, at least greater than the depth of the front recess 225 of the female connector 2 such that during decoupling and when the operator raises the coupling finger 152 of the elastic coupling member 15 by pulling the sleeve 16 rearward, the gap is sufficient to allow the inner section 157 of the hook-shaped portion 154 to completely exit from the front recess 225, thereby achieving decoupling (refer to FIG. 5B).

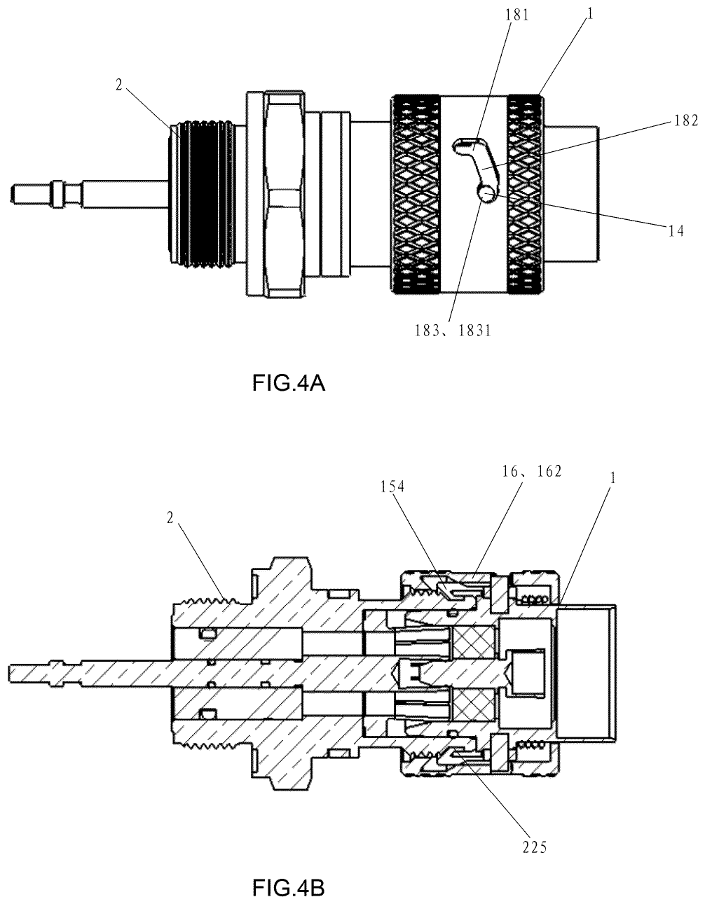

In the initial state of the male connector 1 (refer to FIG. 1B), the inner diameter of the middle section 162 of the sleeve 16 may be smaller than the diameter of the outer surface 1551 of the hook-shaped portion 154 such that the middle section 162 of the sleeve 16 may extrude the hook-shaped portion 154 radially inwardly with the inner surface thereof as the sleeve 16 moves forward (refer to FIG. 4B). The extruded hook-shaped portion 154 undergoes a radially inward elastic deformation, thus the inner section 157 of the hook-shaped portion 154 further extrudes radially inwardly the front recess 225 of the female connector 2 and simultaneously extrudes the flange 226 axially rearwardly based on the inclined direction of the front section 156 such that a firmer coupling of the two connectors 1 and 2 is achieved.

Two radially opposed, respectively circumferentially closed, and radial through slots 18 may be provided on the middle section 162 of the sleeve 16. The slots 18 may be equipped with pins 14 in a corresponding manner. The pin 14 may extend into the slot 18 with the radial outer section thereof, respectively, such that the sleeve 16 is capable of moving as guided by the pin 14. The pin 14 may be flush (refer to FIG. 1B) with or slightly lower than the outer surface 1551 of the middle section 162 of the sleeve 16 with the free end surface of the radial outside thereof, respectively.

Referring to FIG. 1A, each slot 18 may have a front section 181, a middle section 182, and a rear section 183. The front section 181 may have an axially extending orientation. In the initial state of the male connector 1, the pin 14 may be in the front section 181 and the pin 14 may be a certain distance from the front end of the front section 181, the distance being large enough to allow the sleeve 16 to be pulled rearward relative to the pin 14 until the coupling finger 152 of the elastic coupling member 15 completely exits the front recess 225 of the female connector 2 to achieve decoupling of the two connectors 1 and 2. It is evident from the decoupling state shown in FIGS. 5A and 5B that the sleeve 16 moves more rearwardly such that the pin 14 is closer to the front portion of the front section 181 of the slot 18, as compared to the initial state shown in FIGS. 1A and 1B and the coupled and not locked state shown in FIGS. 3A and 3B. In the present example, the pin 14 may be at the rear end of the front section 181 adjacent to the middle section 182, which allows for the sleeve 16 to be rotated directly without having to first push the sleeve 16 forward when subsequently locking is to be achieved.

The middle section 182 may have an obliquely extending or helically extending orientation. That is, the middle section 182 does not extend parallel to, or perpendicular to, the longitudinal axis of the sleeve 16, but rather extends helically about the sleeve 16. The helical orientation of the middle section 182 allows the concurrent axial forward or rearward motion of the sleeve 16 during rotation when the operator rotates the sleeve 16 and the pin 14 is guided towards the sleeve 16 in the middle section 182. The orientation of the middle section 182 may have a smaller angle in the transverse direction (perpendicular to the longitudinal axis of the sleeve 16) of the sleeve 16, for example, less than 45 degrees, or less than 30 degrees, or less than 15 degrees, such that the rotation of the sleeve 16 is easier and less requires less force.

The rear section 183 may have an arcuate front stop cavity 1831 located in the front, which is more towards the front than the rear end of the middle section 182 such that the transition from the rear section 183 to the middle section 182 form a front shoulder 1832. The pin 14 may be partially received and axially stopped in the front stop cavity 1831 (refer to FIG. 4A) based on a rearward force applied to the sleeve 16 by the spring 17. At this point, the pin 14 may be stopped circumferentially by the front shoulder 1832 such that the sleeve 16 is prohibited from automatically reversing past the middle section 182 back to the not locked state shown in FIG. 3A or to the unlocked state. Here, the front stop cavity 1831 may be constructed to receive less than or equal to half of the pin 14, which allows the operator to directly reverse the rotation of the sleeve 16 without first pushing the sleeve 16 forward when unlocking is required, thus facilitating the unlocking operation. In other examples, the front stop cavity 1831 may be constructed to receive greater than half of the pin 14. At this point, to unlock, it is necessary to first push the sleeve 16 forward a certain distance before rotating the sleeve 16 to achieve unlocking. Although this adds one action of pushing the sleeve 16 forward in the unlocking process, it more firmly prevents the sleeve 16 from being inadvertently rotated to unlock.

In examples not shown, the rear section 183 may have a rear stop cavity located at the rear, which is more towards the rear than the rear end of the middle section 182 such that the transition from the rear section 183 to the middle section 182 form a rear convex shoulder. This helps if, when the pin 14 is in the rear section 183, the operator inadvertently pushes the sleeve 16 forward such that the pin 14 exits the front stop cavity 1831 and enters the rear stop cavity, then the sleeve 16 is capable of being stopped circumferentially within the rear stop cavity by the rear convex shoulder such that the sleeve 16 does not rotate circumferentially and unlock under the return force of the spring 17, but returns directly to the front stop cavity 1831 to continue being locked when the operator releases the sleeve 16.

Next, the operating processes comprising coupling, locking, unlocking, and decoupling of the two connectors 1 and 2 are introduced with different states of the two connectors 1 and 2, which are shown in FIGS. 1A, 1B, 3A, 3B, 4A, 4B, 5A, and 5B.

FIGS. 1A and 1B show the separated state of the two connectors 1 and 2, at which point the male connector 1 is in the initial state thereof, the sleeve 16 stops on the elastic coupling member 15 under the pre-tension of the spring 17, and the pin 14 is in the front section 181 of the slot 18, where it is at the rear end of the front section 181 here.

The male connector 1 is inserted into the female connector 2 until the hook-shaped portion 154 of the elastic coupling member 15 is latched into the front recess 225 of the female connector 2, and reaches the coupled state shown in FIGS. 3A and 3B. At this point, the operator is capable of tactilely feeling the vibration (and hearing clicks), prompting that the coupling of the two connectors 1 and 2 is complete. However, the coupling is not locked at this point, and if the male connector 1 is pulled backward with a greater force at this point, the hook-shaped portion 154 may still be raised and exit the front recess 225 to decouple. The pin 14 is still in the front section 181 of the slot 18, i.e., in the same position as in FIG. 1A.

Next, the sleeve 16 is rotated (clockwise from the front) as guided by the pin 14 in the middle section 182 of the slot 18, the sleeve 16 is helically moved forward until the pin 14 enters the rear section 183 of the slot 18. By releasing the sleeve 16, the pin 14 stops in the front stop cavity 1831 of the rear section 183 of the slot 18 under a return force of the spring 17 such that the sleeve 16 is locked by the pin 14, and reaches the coupled and locked state shown in FIGS. 4A and 4B. At this point, the sleeve 16 is moved forward until the inner surface of the middle section 162 thereof presses against the hook-shaped portion 154 of the elastic coupling member 15 to firmly press the hook-shaped portion 154 into the front recess 225 of the female connector 2.

When it is necessary to separate two coupled and locked connectors 1 and 2 from each other, the sleeve 16 is first rotated (counter-clockwise from the front) as guided by the pin 14 in the middle section 182 of the slot 18, and the sleeve 16 moves helically rearwardly until the pin 14 enters the front section 181 of the slot 18, thereby returning to the unlocked state shown in FIGS. 3A and 3B.

Next, the decoupling of the two connectors 1 and 2 is completed as shown in FIG. 5B by pulling the sleeve 16 rearwardly such that the sleeve 16 raises the hook-shaped portion 154 radially outwards until it completely exits from the front recess 225 of the female connector 2, at which point the decoupling of the two connectors 1 and 2 with the sleeve 16 is complete. After decoupling, the male connector 1 is continued to be pulled rearwardly such that it is separated from the female connector 2, and reaches the separated state shown in FIGS. 1A and 1B.

FIGS. 6A and 6B show the installed state of the waterproof cover 3 on the two connected connectors 1 and 2. The waterproof cover 3 is secured on the cable 4 at the rear of the male connector 1 with the rear end thereof, and is constructed to be latched in the rear recess 224 of the female connector 2 with the front end that is constructed as the hook-shaped portion 31.

FIG. 6C shows the state of the waterproof cover 3 being pulled rearwardly to expose the connector assembly, for example, to maintain the connector assembly. In the process of pulling the waterproof cover 3 rearwardly past the sleeve 16, although tension is applied to the sleeve 16 in the locked state, the sleeve 16 will not inadvertently unloosen and enter the unlocked state based on the axial and circumferential stop of the sleeve 16 by the pin 14.

Outstanding features of the examples of the present disclosure include, but are not limited to the following:

Based on the fit of the pin 14 and the slot 18 of the sleeve 16, on one hand, locking and unlocking of the coupling of the two connectors 1 and 2 with the sleeve 16 is achieved by rotating the sleeve 16. In addition, the undesirable unlocking of the sleeve 16 in the locked state based on the stop of the slot 18 as a result of inadvertent application of axial force (e.g., while pulling the waterproof cover 3 for maintenance) is also avoided.

The pin 14 is used not only to lock the sleeve 16 for locking coupling, but also to secure the elastic coupling member 15 on the outer conductor 12, thereby reducing the number of parts and the overall structural dimension of the connector assembly.

In the locked state, the sleeve 16 additionally applies an extrusion force to the hook-shaped portion 154 of the elastic coupling member 15, which in turn applies a radially inward extrusion force and an axially rearward extrusion force to the female connector 2, making the coupling of the two connectors 1 and 2 firmer.

The operator is capable of tactilely (and aurally) identifying that the sleeve 16 is in the locked state and the unlocked state by way of lateral stops of the pin 14 on the rear section 183 of the slot 18 and on the front section 181 of the slot 18, respectively, during the rotation of the sleeve 16.

The present disclosure may comprise any feature or combination of features, or a summary thereof, that is implicitly or explicitly disclosed herein, and is not limited to any of the defined ranges set forth above. Any element, feature, and/or structural arrangement described herein may be combined in any suitable manner.

The specific examples disclosed above are exemplary only and it will be apparent to those skilled in the art who benefit from the teachings herein that the present disclosure may be modified and implemented in different but equivalent ways. It is therefore apparent that the specific examples disclosed above may be changed and modified, and all of these variations are considered to fall within the scope and spirit of the present disclosure.

1. A connector comprising a coaxial central conductor and an outer conductor, wherein the connector further comprises
a coupling member connected to the outer conductor and configured to couple with a mating coupling member of a mating connector;
a sleeve surrounding the outer conductor and is capable of moving between the locked position and unlocked position relative to the outer conductor, the sleeve in the locked position being capable of locking the coupling between the coupling member and the mating coupling member to prevent decoupling of the two, and the sleeve in the unlocked position is capable of allowing decoupling of the coupling member with the mating coupling member;
at least one columnar member connected to the outer conductor; and
at least one slot formed on the sleeve and mated with the columnar member, the slot having a guiding section and a locking section,
in which when the sleeve moves between the locked position and the unlocked position, the columnar member is capable of guiding the sleeve in the guiding section of the slot and when the sleeve is in the locked position, the columnar member is capable of stopping in the locking section of the sleeve such that the sleeve is able to remain in the locked position when subjected to an axial rearward tension.

2. The connector according to claim 1, wherein the guiding section of the slot extends obliquely longitudinally and transversely relative to the sleeve such that movement of the sleeve between the locked position and the unlocked position comprises a helicoidal motion.

3. The connector according to claim 1, wherein the columnar member secures the coupling member to the outer conductor.

4. The connector according to claim 1, wherein the connector further comprises a spring tensioned between the outer conductor and the sleeve that is capable of applying a rearward force to the sleeve.

5. The connector according to claim 4, wherein the locking section has a front stop cavity in the front where, when the sleeve is in the locked position, the spring applies an axial rearward force to the sleeve such that the columnar member stops in the front stop cavity, the front stop cavity having a front shoulder that is adjacent to the guiding section of the slot and circumferentially stops the columnar member.

6. The connector according to claim 5, wherein less than half of the columnar members are received in the front stop cavity when the sleeve is in the locked position.

7. The connector according to claim 5, wherein the locking section has a rear stop cavity in the rear that has a rear shoulder adjacent to the guiding section of the slot, the rear stop cavity being capable of circumferentially stopping the columnar member when the columnar member enters the rear stop cavity.

8. The connector according to claim 4, wherein the coupling member has a base secured to the outer conductor and a plurality of coupling fingers spaced apart by a slit connected to the base in the front, in which the sleeve abuts the coupling fingers from the front in the unlocked position with the force of the spring.

9. The connector according to claim 8, wherein the sleeve in the locked position is capable of abutting the coupling fingers from the radial outside with the inner surface thereof to prohibit the coupling fingers from moving radially outward.

10. The connector according to claim 8, wherein the slot also has a decoupling section that extends longitudinally parallel to the sleeve, and when the sleeve is in the unlocked position, the columnar member is located in the decoupling section and is spaced apart from the front end of the decoupling section, the spacing decreasing after the coupling of the coupling member with the mating coupling member is decoupled by pulling the sleeve rearward.

11. The connector according to claim 8, wherein each coupling finger has a hook-shaped portion having a front end, the hook-shaped portion has an outer section located radially outside, a front section located in the front, and an inner section located radially inside, with the front section extending obliquely.

12. The connector according to claim 11, wherein in the coupled state of the coupling member and mating coupling member, the inner section is latched in the mating coupling member that is constructed as a recess of the matching connector.

13. The connector according to claim 11, wherein when the sleeve is in the locked position, the inner section is latched in the mating coupling member constructed as a recess of the matching connector, and the sleeve abuts the outer section from the radial outside with the inner surface thereof.

14. The connector according to claim 8, wherein the base is constructed as a circumferentially closed ring that is sleeved on the outer conductor.

15. The connector according to claim 3, wherein the outer conductor is provided with at least one radially outwardly open blind via and the coupling member is provided with at least one through hole, and each columnar member is inserted in the slot with one through hole on the lower portion thereof and one blind via on the outer conductor, as well as with the upper portion thereof.

16. A connector according to claim 15, wherein the columnar member is constructed as a pin, the pin is pressed into the through hole and blind via with an interference fit, or the columnar member is constructed as a columnar threaded member that has a threaded connection with at least one of the through hole and blind via.

17. The connector according to claim 1, wherein the slot is constructed to be circumferentially closed.

18. A connector assembly, wherein the connector assembly comprises a connector and a mating connector according to claim 1, in which the mating connector comprises a coaxial central conductor and an outer conductor.

19. The connector assembly according to claim 18, wherein the connector assembly is equipped with a cover radially outside, and when the connector and the mating connector are in the coupled and locked state, the waterproof cover is secured to the cable in the rear of the connector with the rear end thereof and in front of the sleeve with the front end thereof.

20. The connector assembly according to claim 19, wherein the front end of the cover that is constructed as a hook-shaped portion is latched in the recess of the mating connector.
